(19) United States
(12) Patent Application Publication
(10) Pub. No.: US 2018/0246013 A1
(43) Pub. Date: Aug. 30, 2018

(54) SHOCK TESTING APPLICATION FOR A MOBILE COMMUNICATION DEVICE

(71) Applicant: MAT HOLDINGS, INC., Long Grove, IL (US)

(72) Inventors: Jonathon GORE, Whitmore Lake, MI (US); Angad Vasant PATIL, Walled Lake, MI (US); Kevin Robert PAUL, Waterford, MI (US); Chad MONAHAN, Largo, FL (US)

(21) Appl. No.: 15/906,820

(22) Filed: Feb. 27, 2018

Related U.S. Application Data
(60) Provisional application No. 62/464,485, filed on Feb. 28, 2017.

(51) Int. Cl. G01M 17/007; G01M 17/04; G07C 5/08

(52) U.S. Cl. CPC G01M 17/0078; G07C 5/0825; G07C 5/0808; G01M 17/04

(57) ABSTRACT

A method for estimating shock performance of a vehicle using a mobile communication device. Acceleration data is received from one or more motion sensors of the mobile communication device over a period of time while the mobile communication device is placed on a portion of the vehicle and forced vibration is given to a suspension of the vehicle. The received acceleration data is processed to estimate a performance of the shock. The estimated performance of the shock is displayed on a display of the mobile communication device.

### PRIORITY CLAIM

The present non-provisional application claims priority to and the benefit of U.S. Provisional Application No. 62/464,485 filed on Feb. 28, 2017, which is hereby incorporated by reference in its entirety.

### BACKGROUND

The present invention relates to methods and mobile systems for testing vehicle equipment. Example embodiments of the invention relate more particularly to methods and mobile systems for providing a user with a quick estimation of shock absorber (shock) performance of a vehicle based on vibration response and mileage of the shock absorbers, using a mobile communication device.

A vehicle's suspension is made up of multiple linkages with rubber bushings and shock/struts, as well as shock mounts. These components affect the ride quality and response of the vehicle. However, it can be difficult for a user, such as a vehicle owner, to assess the condition of suspension components, or to predict their performance or lifespan. Replacing suspension components such as shocks/struts can be costly, and doing so before it becomes necessary undesirably increases vehicle maintenance costs. However, failure to timely replace such suspension components can hamper the vehicle's ride, comfort, and safety, and can result in unnecessary damage to other components of the vehicle.

Simple visual inspection of the shocks, for instance, or testing by simply pushing down on and bouncing the vehicle (known as a “bounce” test) and visually assessing the result, is often inadequate. Thus, a user typically needs to have a qualified mechanic inspect the shocks, which can be both costly and inconvenient.

Accordingly, there is a need for a method and system for allowing a user to simply and easily obtain a quick estimation of vehicle shock performance that can be more accurate and consistent than a simple visual inspection.

### SUMMARY

The above-listed need is met or exceeded by the present method and system for estimating shock absorber performance of a vehicle. The method and system employ a mobile communication device, such as but not limited to a smartphone, having a mobile application (mobile app) running thereon. As smartphones are already owned by many users, the user does not need to purchase additional testing equipment. Only the mobile communication device running the mobile app is needed.

In an example operation, the user places the mobile communication device on a portion of the vehicle (e.g., a selected corner of the vehicle), which can be prompted by the mobile app using the mobile communication device's display, and pushes down on the vehicle to give forced vibration to the vehicle suspension. The mobile app uses the mobile communication device's motion sensors, e.g., accelerometers, gyroscopes, or other motion sensor or sensors, or a combination, to receive acceleration data at the portion of the vehicle, records acceleration changes, and processes the acceleration changes to estimate damping performance of the shock. Further, example mobile apps use both the estimated damping performance and an estimated shock mileage (wear and tear) input by the user for two decision matrices to grade the shock. The mobile app preferably then displays the results to the user on the mobile communication device's display.

In this way, using a device that is likely already owned by the user, and obtaining (e.g., downloading and storing) and running a mobile app according to example embodiments without additional equipment needed, a user can test his or her shocks in a simple way, with appropriate assistance provided by the mobile communication device. However, the obtained results can be more accurate and consistent than by simply visually inspecting the shocks or by performing a conventional bounce test and observing the results.

More specifically, example embodiments of the invention provide, among other things, a method for estimating shock performance of a vehicle using a mobile communication device. The method comprises: receiving acceleration data from one or more motion sensors, e.g., accelerometers, gyroscopes, or other motion sensors, or a combination, of the mobile communication device over a period of time while the mobile communication device is placed on a portion of the vehicle and forced vibration is given to a suspension of the vehicle; processing the received acceleration data to estimate a performance of the shock; and displaying the estimated performance of the shock on a display of the mobile communication device. In addition to any of the above features in this paragraph, alone or in combination, in an example embodiment estimating performance of the shock comprises estimating a damping performance of the shock; wherein processing the received acceleration data comprises: calculating a damping coefficient using the received acceleration data; and estimating the damping performance based on the calculated damping coefficient. In addition to any of the above features in this paragraph, alone or in combination, in an example embodiment estimating the damping performance comprises comparing the calculated damping coefficient to a table relating damping coefficients to estimated damping performance. In addition to any of the above features in this paragraph, alone or in combination, in an example embodiment calculating the damping coefficient comprises: recording acceleration changes using the received acceleration data; filtering the recorded acceleration changes; converting the filtered acceleration changes to displacement data; and calculating the damping coefficient using the displacement data. In addition to any of the above features in this paragraph, alone or in combination, in an example embodiment calculating the damping coefficient using the displacement data comprises: calculating a logarithmic decrement using peaks in the displacement data; and calculating the damping coefficient using the calculated logarithmic decrement. In addition to any of the above features in this paragraph, alone or in combination, in an example embodiment converting the filtered acceleration changes to displacement data comprises: integrating the filtered acceleration changes to provide velocity data; additional filtering the velocity data; and integrating the additionally filtered velocity data to provide the displacement data. In addition to any of the above features in this paragraph, alone or in combination, in an example embodiment the method further comprises further filtering the displacement data before calculating the damping coefficient using the displacement data. In addition to any of the above features in this paragraph, alone or in combination, in an example embodiment the method further comprises displaying a prompt of the display of the mobile communication device for prompting a user to begin vibrating the vehicle suspension. In addition to any of the above features in this paragraph, alone or in combination, in an example embodiment the prompt comprises a picture of a vehicle; an indicator indicating the portion of the vehicle; and an icon that is selectable by the user to begin vibrating the vehicle suspension. In addition to any of the above features in this paragraph, alone or in combination, in an example embodiment the prompt further comprises a sequence of displayed messages in response to selection of the icon. In addition to any of the above features in this paragraph, alone or in combination, in an example embodiment estimating performance of the shock comprises estimating a damping performance of the shock; and estimating a shock mileage performance based on an estimated shock mileage. In addition to any of the above features in this paragraph, alone or in combination, in an example embodiment the estimated shock mileage is received from an input. In addition to any of the above features in this paragraph, alone or in combination, in an example embodiment, estimating a shock mileage performance comprises: comparing the estimated shock mileage to a table relating estimated shock mileage to estimated shock mileage performance. In addition to any of the above features in this paragraph, alone or in combination, in an example embodiment the method further comprises combining the estimated damping performance and the estimated shock mileage performance to determine an overall shock performance prediction. In addition to any of the above features in this paragraph, alone or in combination, in an example embodiment the method further comprises displaying at least one of the estimated damping performance, the estimated shock mileage performance, or the overall shock performance prediction on the display of the mobile communication device. In addition to any of the above features in this paragraph, alone or in combination, in an example embodiment the method further comprises determining at least one recommendation based on the estimated damping performance, the estimated shock mileage performance, or the overall shock performance prediction on the display of the mobile communication device; and further displaying said determined at least one recommendation. In addition to any of the above features in this paragraph, alone or in combination, in an example embodiment the one or more motion sensors comprises one or more accelerometers.

An example apparatus or system for estimating shock performance of a vehicle using a mobile communication device comprises a processor; and executed instructions stored on a non-transitory medium that when executed by the processor cause the processor to perform a method according to any of the embodiments set forth in the previous paragraph. An example mobile communication device comprises the apparatus or system in this paragraph; the one or more accelerometers; and the display.

An example apparatus for estimating shock performance of a vehicle using a mobile communication device comprises a processor; and executed instructions stored on a non-transitory medium that when executed by the processor cause the processor to: receive acceleration data from one or more motion sensors, e.g., accelerometers, gyroscopes, or other motion sensors, or a combination, of the mobile communication device over a period of time while the mobile communication device is placed on a portion of the vehicle and forced vibration is given to a suspension of the vehicle; process the received acceleration data to estimate a performance of the shock; and display the estimated performance of the shock on a display of the mobile communication device. In an example apparatus, in combination with any of the above features, estimating performance of the shock comprises: estimating a damping performance of the shock; and estimating a shock mileage performance based on an estimated shock mileage. In addition to any of the above features in this paragraph, alone or in combination, in an example apparatus the one or more motion sensors comprises one or more accelerometers.

An example apparatus for estimating shock performance of a vehicle using a mobile communication device comprises: a processor; a damping performance determination module configured for causing the processor to receive acceleration data from one or more motion sensors, e.g., accelerometers, gyroscopes, or other motion sensors, or a combination, of the mobile communication device over a period of time while the mobile communication device is placed on a portion of the vehicle and forced vibration is given to a suspension of the vehicle; a shock mileage determination module configured for causing the processor to estimate a shock mileage performance based on an estimated shock mileage; a prediction determination module configured for causing the processor to combine the estimated damping performance and the estimated shock mileage performance to determine an overall shock performance prediction; a user prompt module configured for causing the processor to prompt a user to begin oscillating the vehicle; and a results display module configured for causing the processor to display one or more of the estimated damping performance, the estimated shock mileage performance, or the overall shock performance prediction on the display of the mobile communication device. The apparatus can further comprise any of all of a display or one or more motion sensors. In an example embodiment, the one or more motion sensors comprises one or more accelerometers. An example mobile communication device can include any of the above features.

### BRIEF DESCRIPTION OF THE DRAWINGS

FIG. 1 is a diagram of an example mobile communication device;

FIG. 2 is a diagram of example modules for an example mobile application running on a mobile communication device;

FIG. 3 is an example process for estimating shock performance of a vehicle using a mobile communication device, such as a phone;

FIGS. 4A-4B are an example opening screen and an example vehicle input and history screen;

FIGS. 5A-5D are example screens illustrating a vehicle input sequence;

FIGS. 6A-6C are example screens illustrating a vehicle profile input sequence;

FIGS. 7A-7D are example screens illustrating a test prompting sequence;

FIG. 8 shows a mobile communication device, illustrating example X, Y, and Z axes for a damping performance test;

FIGS. 9A-9C show steps in an example method for calculating a damping coefficient;

FIG. 10 shows an example logarithmic decrement;

FIG. 11 shows an example damping coefficient calculation based on a logarithmic decrement;

FIG. 12 is a graph illustrating damping;

FIG. 13 is an example grading scheme table relating damping coefficients (vibration response) to various severities of damping performance;

FIG. 14 is an example grading scheme table relating shock mileage for a vehicle (for example a car) to various severities of damping performance;

FIG. 15 is an example grading scheme table relating vibration response damping performance scores and shock mileage performance scores, and combined weighted scores, to an overall predicted performance score;

FIG. 16 is an example table relating overall predicted performance to a prediction;

FIG. 17A is an example test report screen displaying additional example results with an input vehicle profile;

FIG. 17B is a test report screen showing summarized results for four corners of a vehicle (only the front left corner has been tested so far in this example), and a link for obtaining replacements parts via the mobile communication device;

FIG. 17C shows an email input screen linked to the mobile app;

FIG. 18A shows an example parts list screen;

FIG. 18B shows an example customer service call screen;

FIG. 18C shows an example part information screen; and

FIG. 18D shows an example retailer navigation screen.

### DETAILED DESCRIPTION

Example embodiments of the invention provides a quick, approximate estimation of the vehicle's shock performance. It can be difficult to determine the performance of the rubber bushings and the mounts using a mobile communication device's (e.g., phone's) built-in motion sensor or sensors; e.g., one or more accelerometers, gyroscopes, or other motion sensors, or a combination of motion sensors. However, the response of the shock can be captured approximately.

Because shock performance is being considered irrespective of the bushing performance, an example evaluation matrix is divided into vibration response (performance) and mileage of the shock (overall life/wear and tear). Few assumptions about shock absorber life are made based on industry standard shock life (e.g., 50,000 miles of life). Thus, in some example methods, both the determined damping performance of the shock and the shock mileage performance are estimated, and combined into an overall predicted performance.

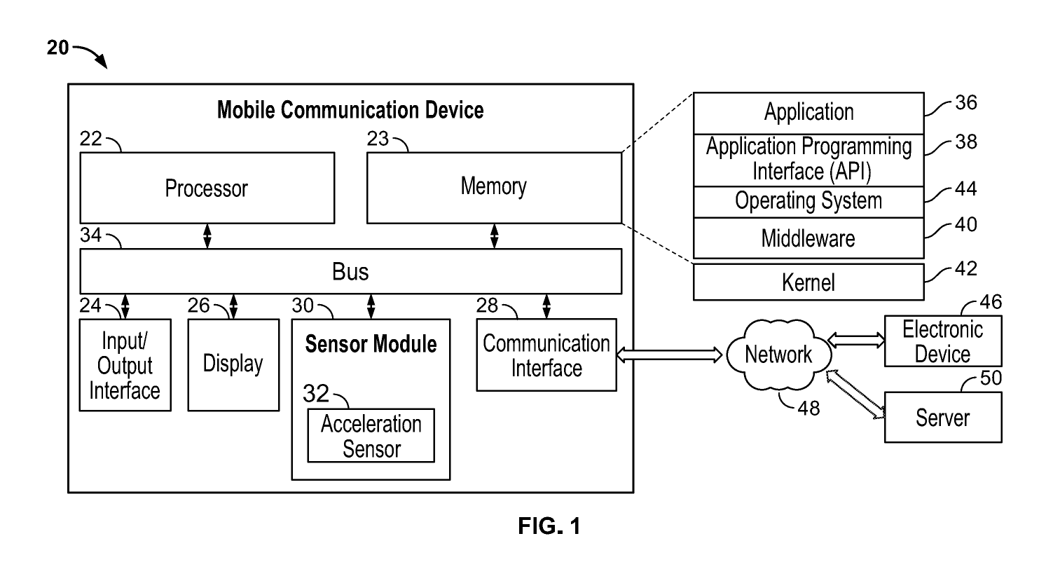

Referring now to FIG. 1, a mobile communication device 20 is provided for performing example methods of the invention. Preferably, but not necessarily, each step of an example method is performed by a single mobile communication device 20, such as a user's mobile phone or tablet. In this way, a user can obtain a quick estimation of a vehicle's shock performance using only the mobile communication device 20, which is placed on a portion of the vehicle (such as a corner of the vehicle, as disclosed further herein).

The mobile communication device 20 includes a processor 22, a memory 23, an input/output interface 24, a display 26, a communication interface 28, and a sensor module 30 that includes an accelerometer 32 (and can include other sensors). Instead of or in addition to an accelerometer or accelerometers, gyroscopes or other motion sensors, or a combination of motion sensors, can be provided. The processor 22, memory 23, input/output interface 24, display 26, communication interface 28, and sensor module 30 can communicate via a bus 34. An example mobile communication device 20 used herein for executing an example mobile app is a smartphone, tablet computer, or other so-called “smart” device, such as but not limited to IPHONE™ or IPAD™ by Apple, Inc., GALAXY™ devices by Samsung, or PIXEL™ by Google, Inc., though of course other mobile communication devices can be used. The memory 23 can include transitory (e.g., random access memory (RAM) and others) and non-transitory memory, and may have stored therein applications 36 including example mobile apps as disclosed herein, along with suitable application programming interfaces (API) 38, middleware 40, kernels 42, operating system (OS) 44, etc., as will be appreciated by those of ordinary skill in the art. The mobile app may be stored in a non-transitory memory and/or non-transitory memory or a storage medium (computer-readable medium) for execution by the processor 22. The mobile communication device 20 preferably can communicate with other electronic devices 46 either over a direct link (not shown), or via a network 48, and preferably can connect with one or more servers 50 over the network. As will be appreciated by those of ordinary skill in the art, the mobile app can preferably be downloaded for installation and/or updates onto the mobile communication device over the Internet, through an application store or “app store,” directly through a storage device, pre-installed on the device, or in other ways.

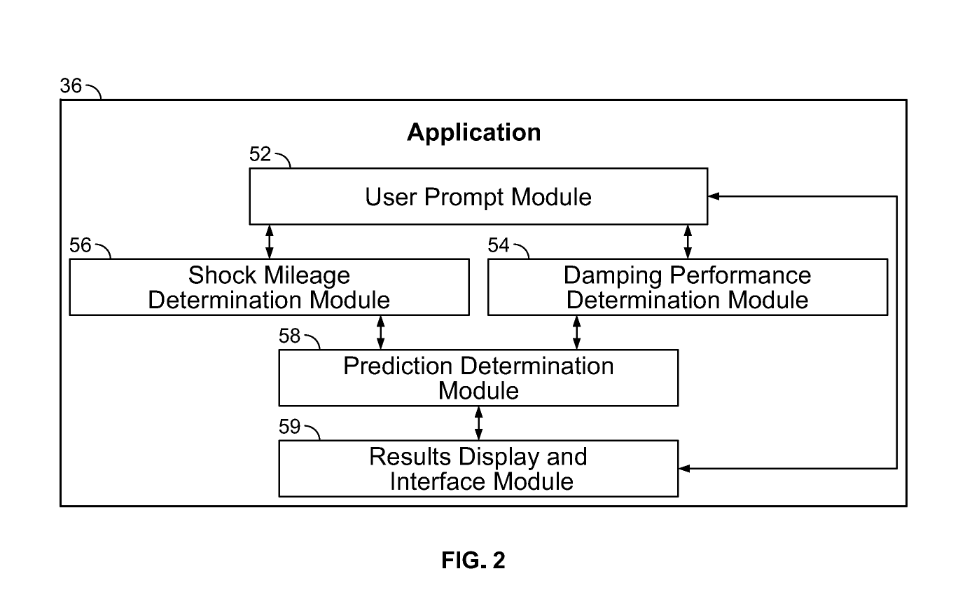

FIG. 2 shows components of an example mobile app. A user prompt module 52 is provided for prompting a user via the mobile communication device 20 to perform a damping performance test at a portion of a vehicle, as will be explained elsewhere herein. A damping performance determination module 54 is provided for receiving signals from the accelerometer 32 or other motion sensor during a damping performance test, and determining damping performance. A shock mileage performance determination module 56 is provided for receiving user input regarding an estimated or actual shock mileage, and determining shock mileage performance based on the shock mileage. A predicted shock performance determination module (prediction determination module) 58 is provided for determining a predicted performance of the shock based on the determined damping performance and the determined shock mileage performance. A results display module 59 is provided for displaying results of the predicted shock performance determination module 58, the damping performance determination module 54, and/or the shock mileage performance determination module 56.

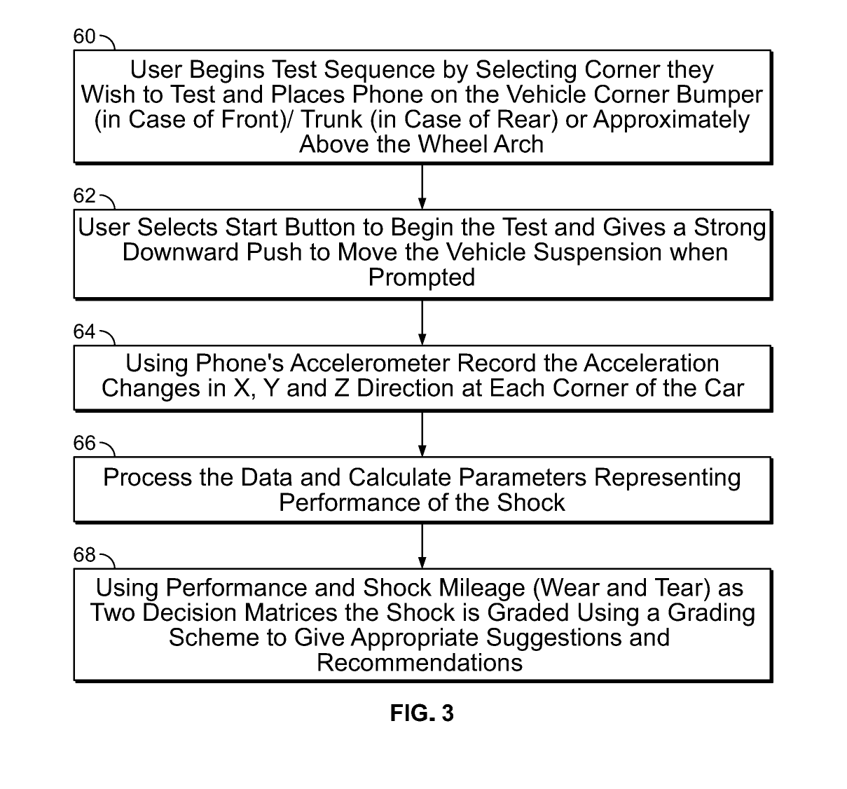

FIG. 3 shows an example process for estimating shock absorber performance of a vehicle, such as but not limited to a car, using the example mobile app. In step 60, a user begins a test sequence by selecting a portion (e.g., corner) of the vehicle he/she wishes to test on the display 26 of the mobile communication device 20, and places the mobile communication device on the selected portion of the vehicle, e.g., on the vehicle corner bumper (in case of front) or on the trunk (in case of rear) or approximately above the wheel arch. In an example method, the mobile app, e.g., the user prompt module 52, displays the selected corner of the vehicle on the display 26, and a prompt, e.g., “Tap to Test,” is depicted on the display.

In step 62, the user selects a “Start” button on the display 26 to begin the test, which selection is received by the mobile app. The user then gives a strong downward push, e.g., on the selected corner of the vehicle or as close to the suspension tower as possible of that selected corner, to move the vehicle suspension when prompted, giving vibrations to the vehicle suspension. In an example method, the mobile app, e.g., the user prompt module 52, causes the display 26 to provide a series of screen prompts, e.g., “Get Ready,” “Get Set,” “Bounce!”

In step 64, the mobile communication device's accelerometer (or other motion sensor(s), though accelerometers will be described in example embodiments) senses velocity changes in the X, Y, and Z direction at each corner of the vehicle and provides signals indicating these velocity changes. The mobile app, e.g., the damping performance determination module 54, receives the signals from the accelerometer and records the velocity changes. The user can also input an estimated (or actual) mileage of the shock, which mileage is received by the mobile app and recorded.

In step 66, the accelerometer data is processed by the damping performance determination module 54, and parameters are calculated representing performance of the shock. In step 68, using performance as determined by the damping performance determination module 54 as a first decision matrix, and received shock mileage (wear and tear) as processed by the shock mileage performance determination module 56 as a second decision matrix, the shock is graded using a grading scheme by the prediction determination module 58 to give appropriate suggestions and recommendations. In an example method, the results display module 59 causes the mobile communication device's display 26 to depict a performance score, a mileage score, and an overall score, along with a recommendation. A visual icon can be provided to graphically indicate one or more recommendations.

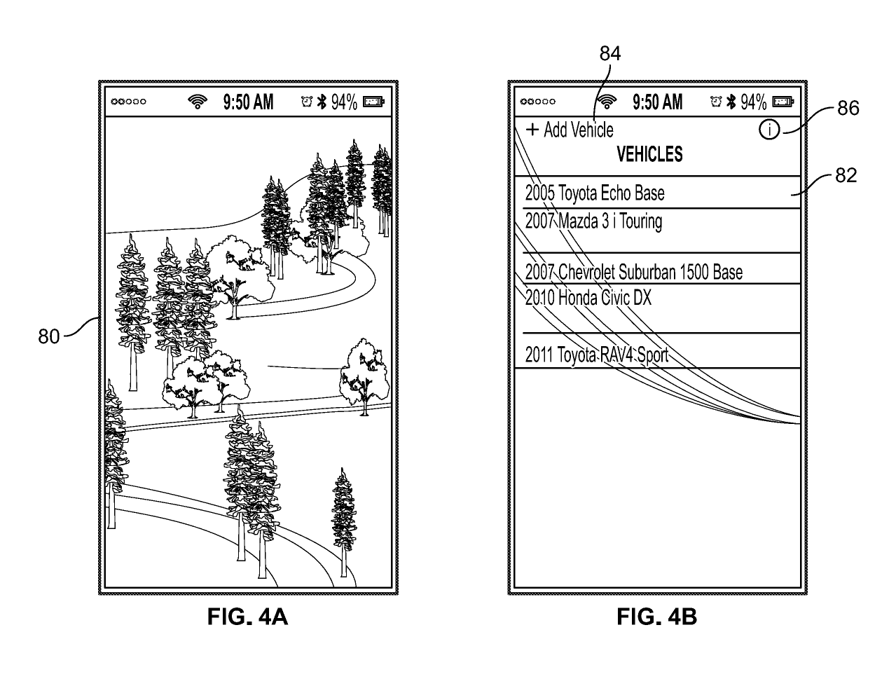

For illustrating an example operation of the mobile app, FIGS. 4A-7D and 16A-18D show example screenshots displayed by the mobile communication device 20, such as but not limited to a mobile phone, e.g., IPHONE™ by Apple, Inc., running an example mobile app in a mobile operating system, e.g., iOS. The mobile app displays an app opening screen 80 on the mobile communication device display (FIG. 4A). A vehicle input and history screen (FIG. 4B) is then displayed for indicating vehicles 82 that have previously been selected by the user. The order of displayed vehicles can be based on most recent vehicle entered, frequency, or in other ways. The user can select one of the previously displayed vehicles, or can add a new vehicle. An icon 84 is displayed for adding a vehicle, and another icon 86 is displayed for providing instructions for using the mobile app.

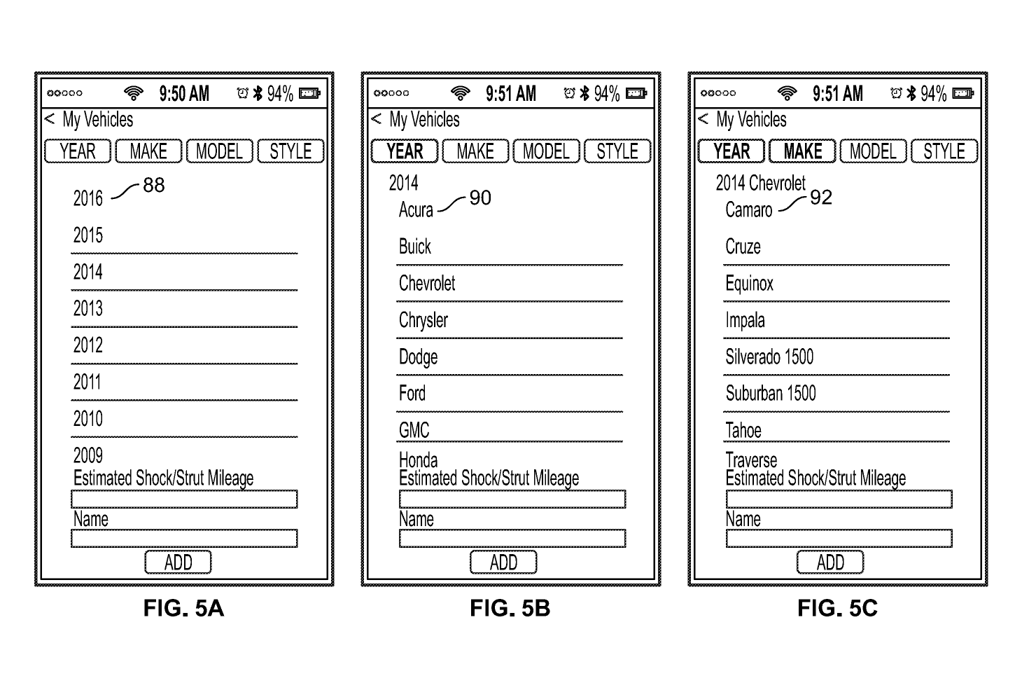

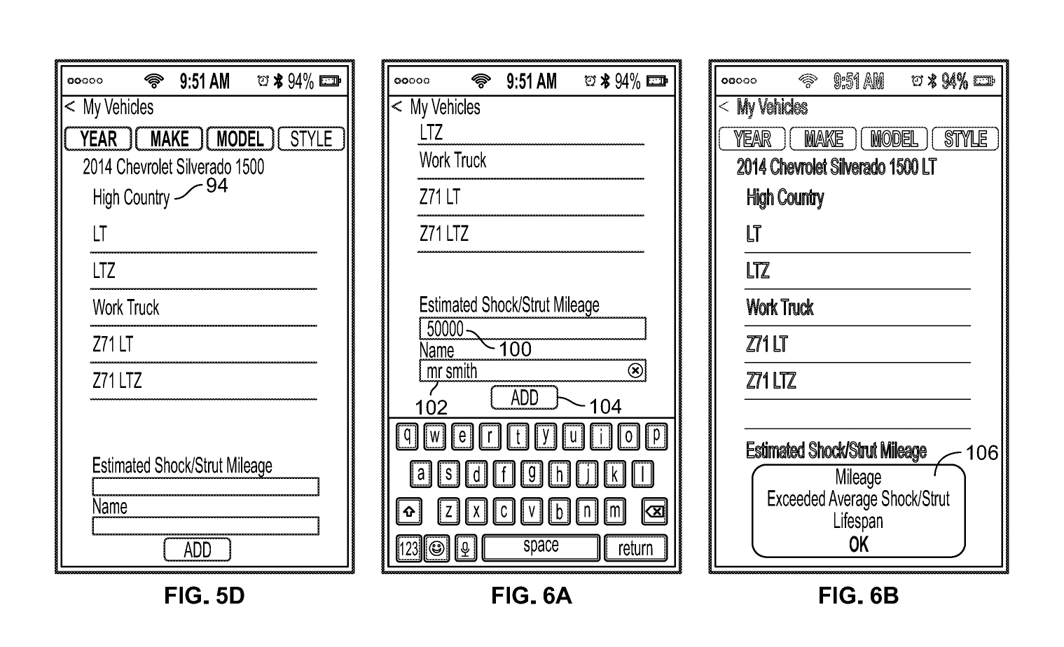

FIGS. 5A-5D show an example method for adding a new vehicle. In FIG. 5A, a list of available vehicle model years is retrieved, and a scrollable, selectable list 88 of vehicle model years is displayed. Retrieving by the mobile app can be, e.g., from memory, from storage, from a network, etc. This list preferably can be updated as needed, e.g., a new model year may be added. Given a received year selection, e.g., “2014,” a list of available vehicle makes for the selected year is retrieved, and a scrollable, selectable list of vehicle makes 90 is displayed (FIG. 5B). Next, as shown in FIG. 5C, given a vehicle make selection, e.g., “2014 Chevrolet,” a list of corresponding vehicle models is retrieved, and a scrollable, selectable list of vehicle models 92 is displayed. Then, as shown in FIG. 5D, given a vehicle model selection, e.g., “2014 Chevrolet,” a list of corresponding vehicle styles is retrieved, and a scrollable, selectable list of vehicle styles 94 is displayed. A user can then select one of the displayed vehicle styles to complete selection of the vehicle for testing. It will be appreciated that selection of a particular vehicle style can be performed in a different sequence, e.g., make/model/year/style, or in any other suitable sequence. The mobile app further preferably allows a user to go back or forward through the selection process if needed.

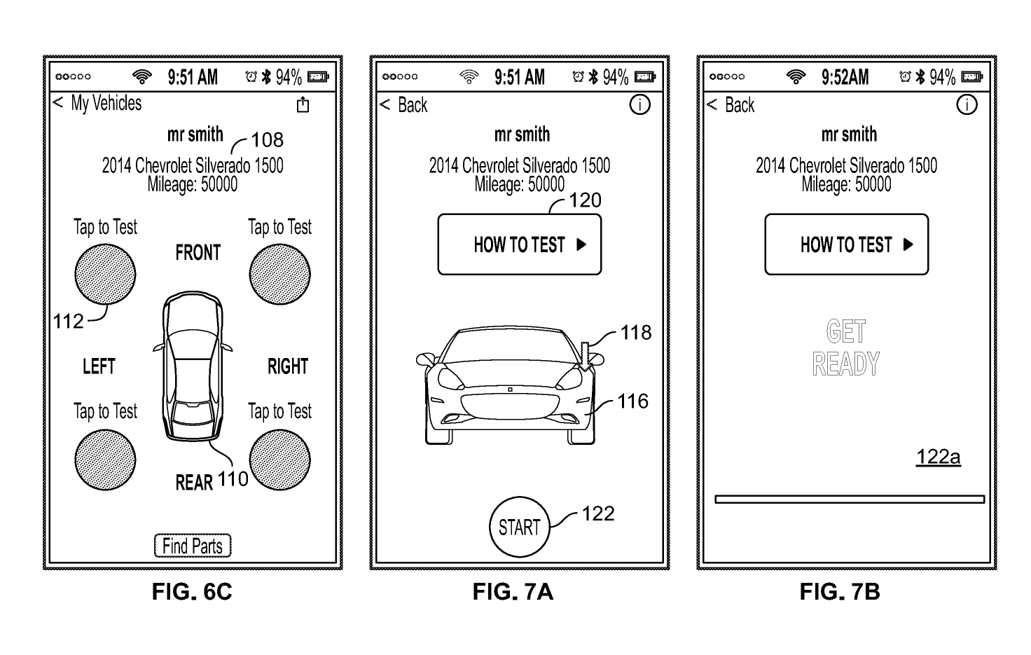

As shown in FIGS. 6A-6C, a vehicle profile input sequence is provided, which can be provided using the mobile app in combination with the mobile communication device display 26 and input/output interface 24. The mobile app displays an input, e.g., form fields 100 or other inputs, for an estimated shock/strut mileage. An additional input 102 may be provided for input of a user name, e.g., “Mr. Smith”. An icon, e.g., an “Add” button 104, widget, or other input is provided for accepting and selecting the user input. The mobile app receives the vehicle (e.g., including year, make, model, and style, or any subset of these) and the estimated shock/strut mileage.

The mobile app may perform an initial comparison of the estimated shock/strut mileage to a predetermined set of parameters, for example, to determine if this mileage can be used for further processing, e.g., if the estimated shock/strut mileage is realistic. This initial comparison additionally or alternatively can be used to display a message to the user. For example, as shown in FIGS. 6A-6B, the input shock/strut mileage is 50000. The mobile app displays a popup message 106 (FIG. 6B) indicating that the input mileage exceeds the average shock/strut lifespan.

As shown in FIG. 6C, the mobile app then provides a summary 108 of the received vehicle selection and vehicle profile, along with an illustration 110 of a vehicle, which illustration preferably at least generally resembles the selected vehicle. The user prompt module 52 prompts the user to begin a damping performance test. For example, at each of four corners of the vehicle, a selection icon, “Tap to Test” 112, is provided for graphically indicating to the user where a user can begin the damping performance test, and for receiving a user selection of which portion of the vehicle (e.g., vehicle corner) is being used for the test. A user selects one of the four selection icons 112 to begin the damping performance test.

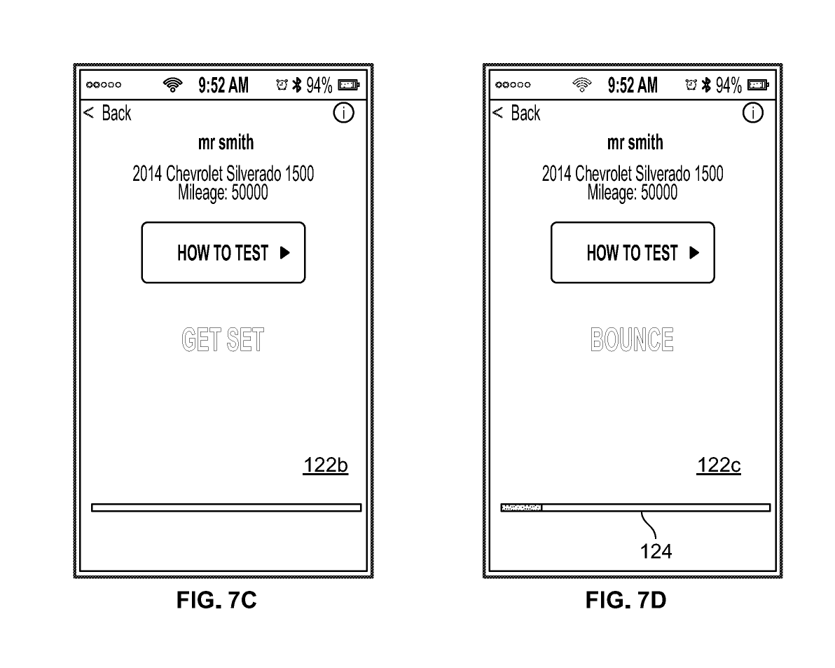

FIGS. 7A-7D show screenshots displayed by the mobile communication device 20 in an example test prompting sequence. The user prompt module 52 of the mobile app (in combination with the display 26) displays at least a portion of a vehicle 116 including the selected area being used for the damping performance test. An indicator 118, e.g., an arrow, can be displayed to indicate to the user where the mobile communication device 20 is to be physically placed on the vehicle. An icon 120 is preferably provided on the display for providing directions for testing.

A start icon 122 is also displayed for receiving a confirmation that the user is ready to start the damping performance test. The user places the mobile communication device 20 on the vehicle, preferably at the portion of the vehicle indicated in the display, and selects (e.g., taps) the start icon 120. The user prompt module 52 then displays a prompt on the mobile communication device display 26 for the user to start oscillating (e.g., bouncing) the vehicle. For example, as shown in FIGS. 7B-7D, the prompt is provided by a sequence of three screens 122a, 122b, 122c indicating “Get Ready,” “Get Set,” “Bounce!” Sounds may also be provided for prompting the user.

Once prompted, the user then gives a strong downward push to the vehicle having the mobile communication device 20 disposed thereon, e.g., on the corner of the vehicle on which the mobile communication device is disposed, and the mobile communication device's accelerometer 32 produces signals indicating velocity changes in x, y, and z directions at the selected corner of the vehicle, which are received by the mobile app and recorded. After a period of time, e.g., 5 seconds (though times greater than or fewer than 5 seconds are possible), as indicated by example using a progress bar 124, the user is prompted to stop pushing on the vehicle, e.g., by a new display, by a sound, etc. to complete the bounce test.

Once the bounce test input is complete, the mobile app then records (at least temporarily) and processes the received acceleration data and the received shock mileage input, and calculates parameters representing performance of the shock. In an example method, the damping performance determination module 54 determines a damping coefficient, and then determines a damping performance score based on the determined damping coefficient. This uses the shock damping performance as a first decision matrix for grading the shock. Preferably, the shock mileage determination module 56 also determines the shock mileage/life score based on the received shock mileage input. This uses the shock mileage/life as a second decision matrix for grading the shock. The prediction determination module 58 then combines the damping performance score and the shock mileage/life score, and grades the shock's overall predicted performance as an overall shock performance score, which can then be presented to the user.

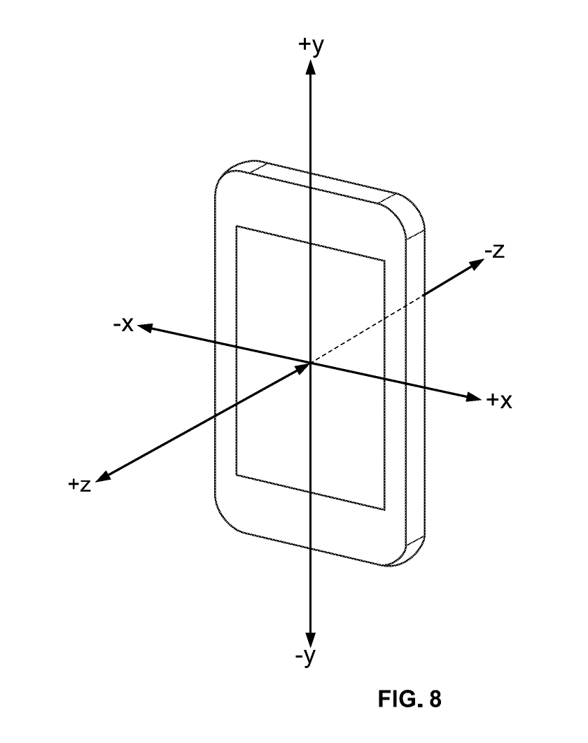

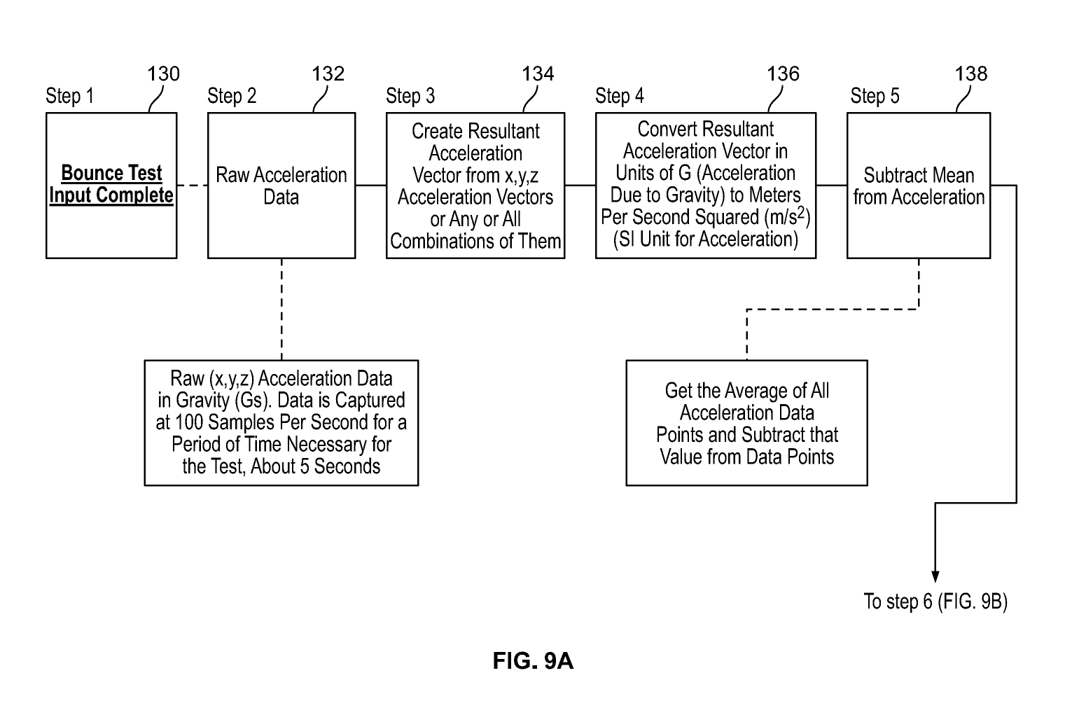

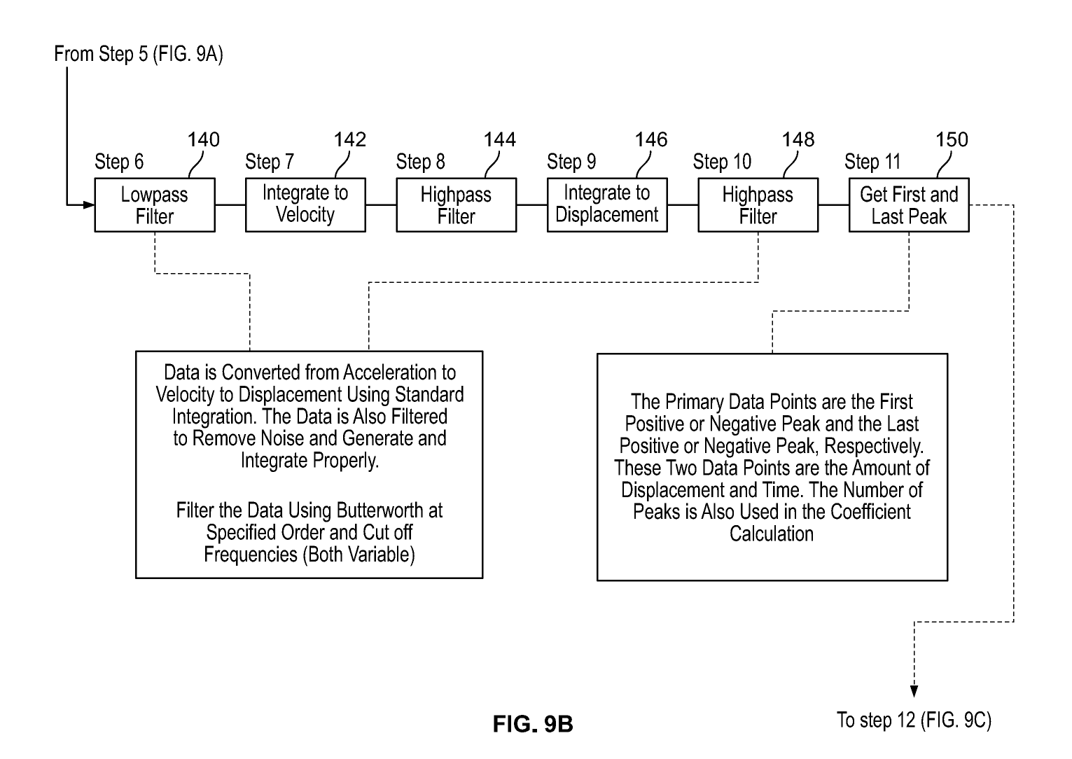

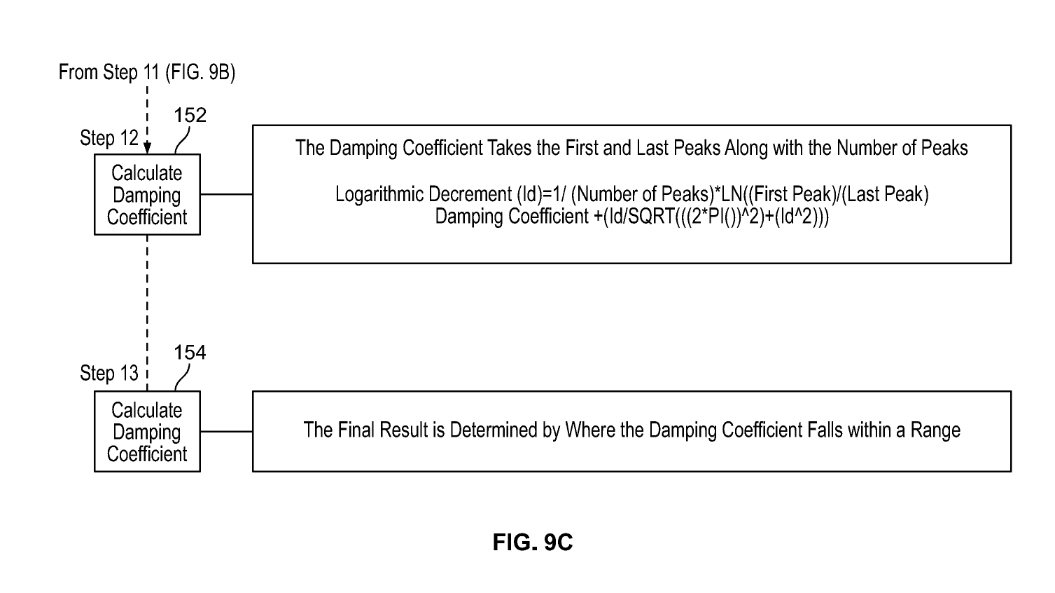

FIGS. 9A-9C show an example method performed by the mobile app for determining a damping coefficient and for determining a damping performance score. In step 130, it is determined whether the bounce test input is complete. Raw acceleration data is captured in step 132. For example, raw (x, y, z) acceleration data may be captured in gravity units (Gs). For illustration, FIG. 8 shows an example mobile phone. Example X, Y, and Z axes are also shown with respect to the mobile phone, though the specific orientation of the X, Y, and Z axes can vary. During the test, data, particularly sensed velocity changes, is captured at a particular sample rate, e.g., 100 samples per second (though the sampling rate can vary) for a period of time necessary for the test, e.g., about 5 seconds (though this also can vary). In step 134 a resultant acceleration vector is created from x, y, z acceleration vectors or any or all combinations of them, and in step 136, the vector data is converted from G to meters per second squared (m/s²) (acceleration in SI units, though other units could be used). Next, in step 138, the mean (average) of all acceleration data points is determined, and the mean is subtracted from all data points.

Next, the acceleration data is converted from acceleration to velocity to displacement, e.g., using standard integration. The data is also filtered to remove noise, and reduce integration error. For example, in step 140, the acceleration data is lowpass filtered, and in step 142, the filtered acceleration data is integrated to determine velocity. The velocity data is then highpass filtered in step 144, and the filtered velocity data is integrated to determine displacement in step 146. The displacement data is again highpass filtered in step 148. An example filter uses Butterworth at specified order and cut off frequencies, which can both be variable. In an example embodiment, based on data analysis, a low pass filter of 4^{th} order at 10 Hz and a high pass filter of 6^{th} order at 0.3 Hz were selected. These values provided good data filtration in example tests. However, these values can vary. Sample tests can be run to select and/or optimize the order and/or cut off frequencies.

Next, from the filtered displacement data, the first positive or negative peak and the last positive or negative peak respectively are determined in step 150. These two data points can be used as primary data points to determine the amount of displacement and time. The number of peaks can also be used for a coefficient calculation.

The damping coefficient is then determined in step 152. In an example method, the damping coefficient is determined by first taking the first and last peaks of the filtered displacement data along with the number of peaks and calculating the logarithmic decrement. The logarithmic decrement can be calculated by:

Logarithmic Decrement (ld)=1/(number of peaks)*LN[(first peak)/(last peak)]

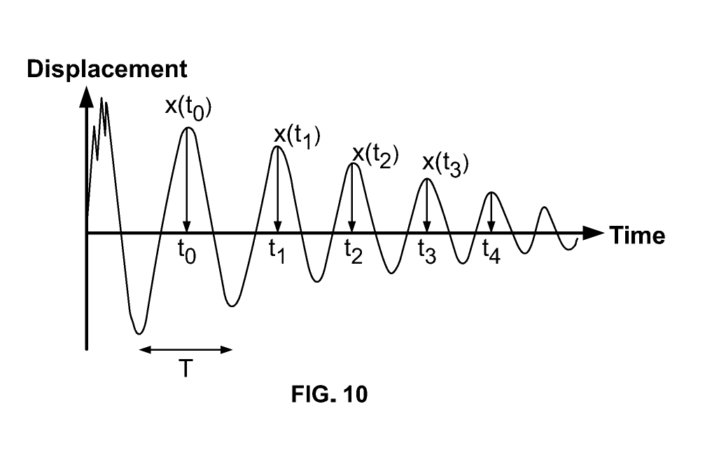

Logarithmic decrement is used as a measure to determine how the vibrations die out, and in turn determines the damping. For example, as shown in FIG. 10, the logarithmic decrement is a quantity defined as

$$δ = ln ( \frac{x ( {t}_{n} )}{x ( {t}_{n + 1} )} ) ,$$

where x(tₙ) is the displacement at the nth peak. In principle, δ can be calculated by selecting any two neighboring peaks. It is often more accurate to estimate δ using the formula

$$δ = \frac{1}{n} ln ( \frac{x ( {t}_{o} )}{x ( {t}_{n} )} ) .$$

The logarithmic decrement is then used to calculate the damping coefficient. The damping coefficient can be determined by

$$Damping Coefficient = ζ = \frac{δ}{\sqrt{4 {π}^{2} + {δ}^{2}}}$$

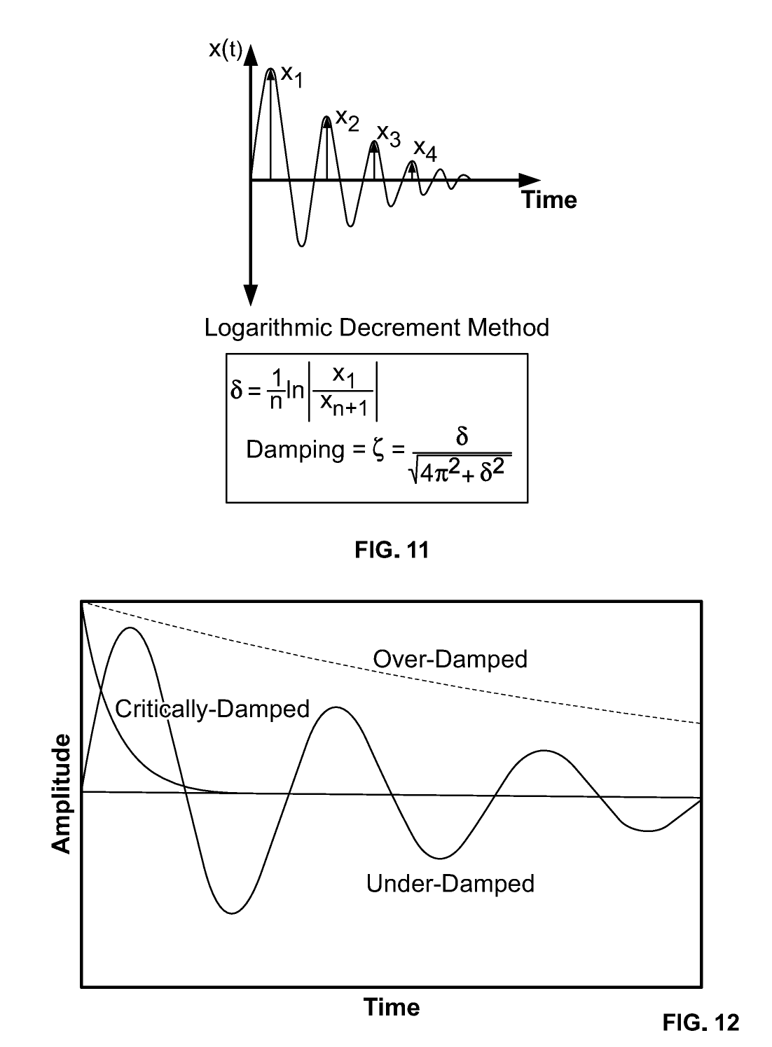

FIG. 11 shows an example method for determining damping coefficient, which is a measure of damping. FIG. 12 shows an example relationship between time and amplitude for over-damped, critically damped, and under damped states. Using the logarithmic decrement

$$δ = \frac{1}{n} ln \vert \frac{{x}_{1}}{{x}_{n + 1}} \vert ,$$

the damping coefficient can be calculated by

$$Damping = ζ = \frac{δ}{\sqrt{4 {π}^{2} + {δ}^{2}}} .$$

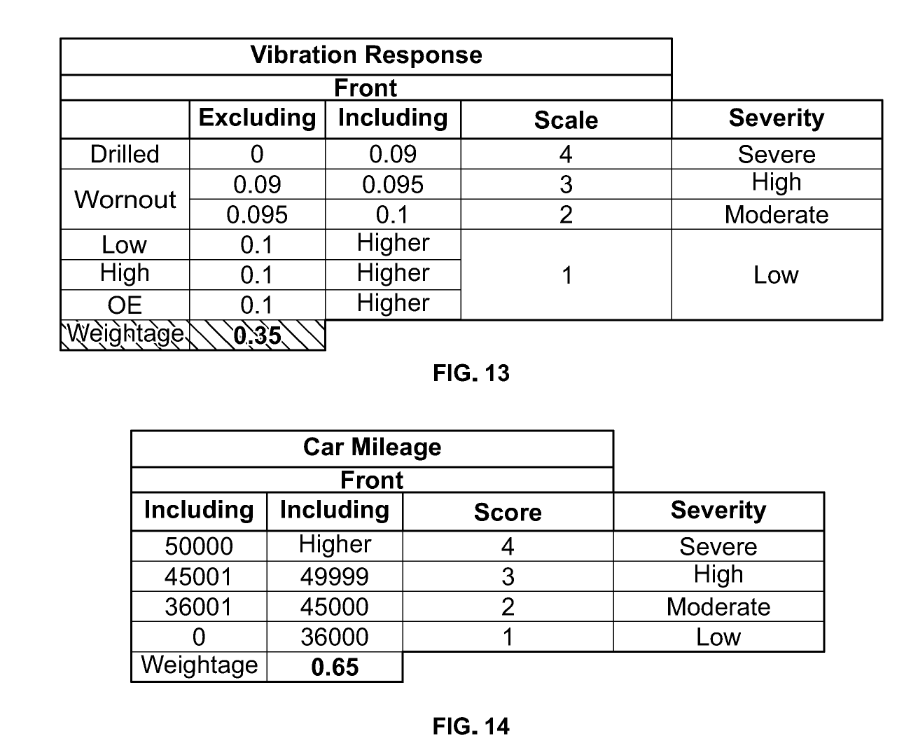

To determine a damping performance score based on the calculated damping coefficient value, the damping coefficient value can be compared to a range to determine where the damping coefficient falls within the range. This determines the final result in step 154. For example, FIG. 13 shows an example grading scheme using damping performance data collection. To provide a predetermined table relating damping coefficients values to damping performance scores, damping coefficient values are determined using a data collection application configured to measure various shocks for a vehicle: 1) a worst performing shock—shock without oil (Drilled); 2) LOW damping force shock sample; 3) HIGH damping force shock sample; and 4) an original equipment (OE) shock. In an example method, the set of shocks were installed—one on the front corner of the vehicle and one on the rear corner (either side). Using example data collection methods, such as via a data collection app configured to perform the above steps, damping coefficient values are obtained for all of the above cases.

The resulting damping coefficients are divided approximately in ranges to show performance grades and scores, e.g., Severe, Low, Moderate, and High. The performance grades can be assigned predetermined scores, e.g., 1 to 4, with 4 being high severity (worst performance) and 1 being low severity (best performance) and stored in a table (damping performance matrix). The table can be predetermined or created/modified based on new results. The result obtained by comparing the calculated damping coefficient value to this table provides a damping performance score. It will be appreciated that the particular numerical scores and number of ranges can vary. Tables can be stored in the mobile communication device 20 or obtained (e.g., downloaded) as needed. Tables can, but need not, vary for various vehicles or vehicle types. Instead of a predetermined table, a mathematical or other relationship can be derived and used for converting damping coefficients to damping performance scores.

Additionally, in some example methods, shock mileage (wear & tear), which can be received via user input in the mobile communication device 20 when prompted by the mobile app, e.g., as shown in FIG. 6A, is further used to determine shock performance. For example, the mobile app can compare the input (including input in real time, or previously input and stored) shock mileage to a predetermined table relating care mileage to a shock performance score to provide a grading scheme.

In an example method, an industry standard shock mileage (e.g., 50,000 miles and above) can be used as a reference high shock life (reference shock life), while an industry standard optimal shock mileage life (e.g., 36000 miles and below) can be used as a reference low shock life (best shock mileage life). There can also be one or more levels between the reference high and reference low shock life, which can be determined by interpolating linearly or otherwise, by incorporating additional reference data, or in other ways. The example table, or shock mileage/life matrix, an example of which is shown in FIG. 14, thus breaks shock mileage into a plurality of predetermined ranges, and assigns a predetermined score (e.g., 1 to 4, with 4 being most severe, and 1 being low severity) to each range. Alternatively, the shock mileage/life matrix can be created or modified on the fly. The input shock mileage can then be compared to the table to obtain a shock mileage score. As with the damping performance score, tables for determining the shock mileage performance score can be stored in the mobile communication device 20 or obtained (e.g., downloaded) as needed. Tables can, but need not, vary for various vehicles or vehicle types. Instead of a predetermined table, a mathematical or other relationship can be derived and used for converting shock mileage to shock mileage performance scores.

The damping performance and the shock mileage, e.g., via the damping performance score and the shock mileage score from the damping performance matrix and the shock mileage/life matrix, can then be used to predict overall shock performance, e.g., by combining the scores and determining an overall predictive value. Preferably, but not necessarily, the damping performance score and the shock mileage score are weighted before combining. In a non-limiting example, the shock mileage score is given a 65% weight, while the shock performance score is given a 35% weight. However, these weights can vary. Each weight can vary from 0% (no weight) to 100% (complete; e.g., if only one score is used).

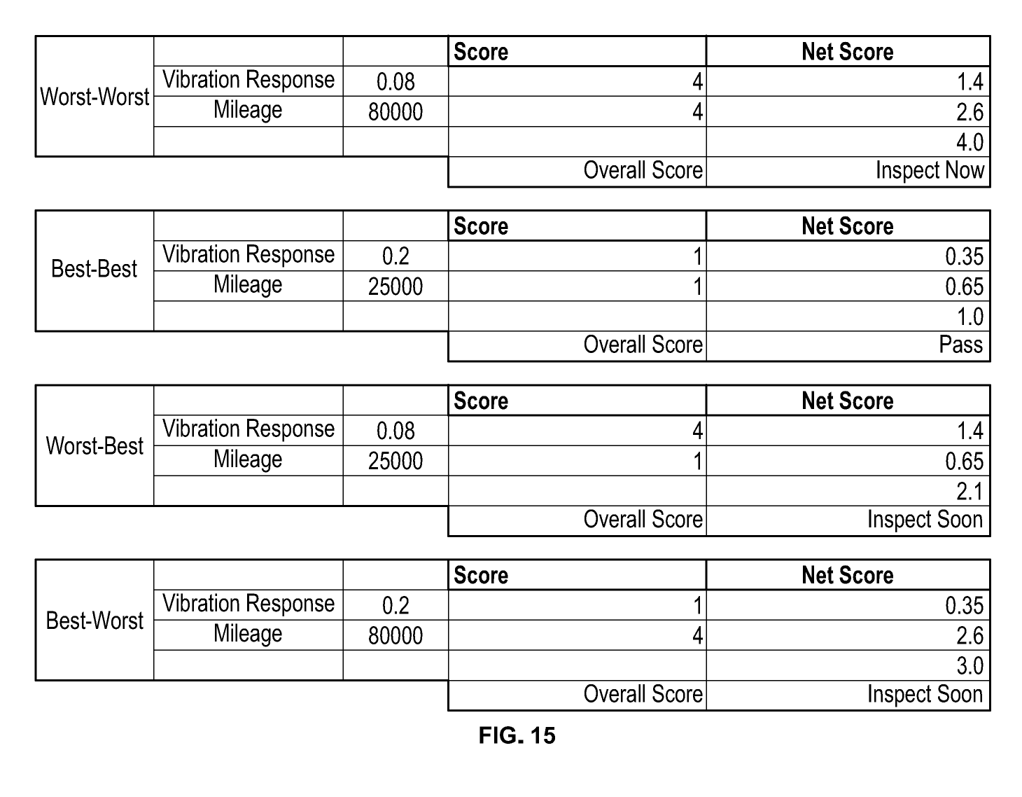

The damping performance score is multiplied by the weight factor assigned to that score (e.g., 35% weight) to provide a first net score, and the shock mileage score is multiplied by the weight factor assigned to that score (e.g., 65% weight) to provide a second net score. The first and second net scores are then combined (e.g., added) to provide an overall predictive value. FIG. 15 shows example tables combining first and second net scores in four performance cases: worst-worst (net score of 4), best-best (net score of 1), worst (shock performance)-best (mileage) (net score of 2.1), and best (shock performance)-worst (mileage) (net score of 3.0).

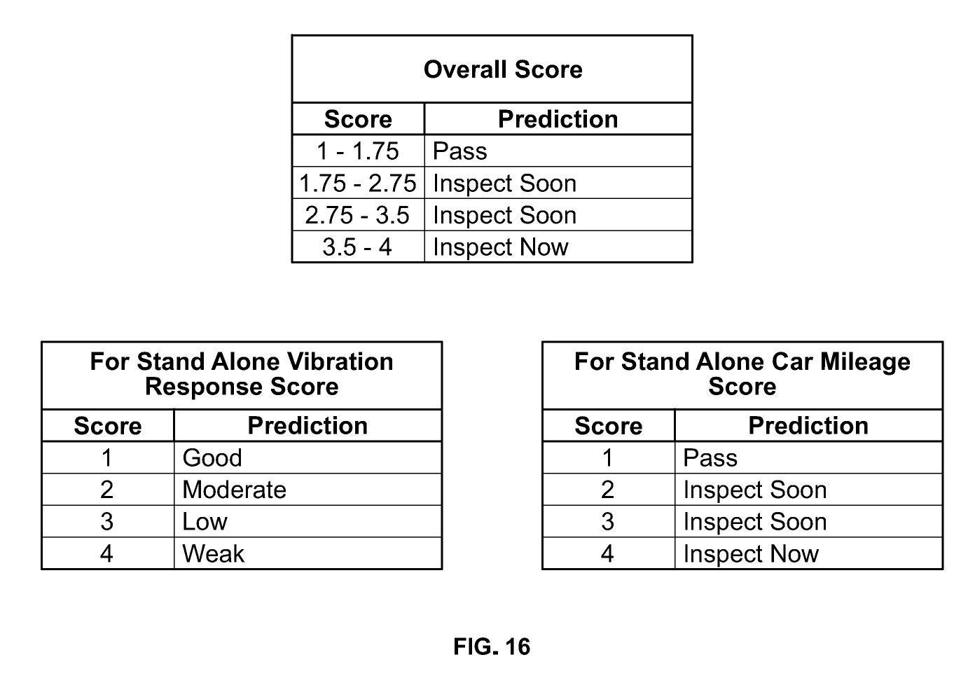

The overall predictive value (overall score) can then be compared to a predetermined table to additionally grade overall performance. For example, FIG. 16 shows a table with example predetermined ranges for overall predictive values. In some example grading schemes, an overall score between 3.5-4 is associated with a prediction “Need Replacement” or “Inspect Now,” 2.75-3.5 is associated with “Change Soon” or “Inspect Soon,” 1.75-2.75 is associated with “Recommend Inspection” or “Inspect Soon,” and 1.75 and below is associated with “Do not recommend change” or “Pass.” Discrete ranges, sliding scales, or other comparisons may be used.

The mobile app, for instance the results display module 59, preferably then causes the mobile communication device 20 to display the determined shock performance, which can include the graded overall performance, the overall predictive value, or include the overall performance and/or predictive value along with the separate damping performance and shock mileage performance and or/predictive value scores. The displayed results can include one or more of the damping performance score (weighted or unweighted), the damping coefficient, the shock mileage/life score (weighted or unweighted), the input shock mileage, and the overall shock performance prediction score as a calculation of weighted scores.

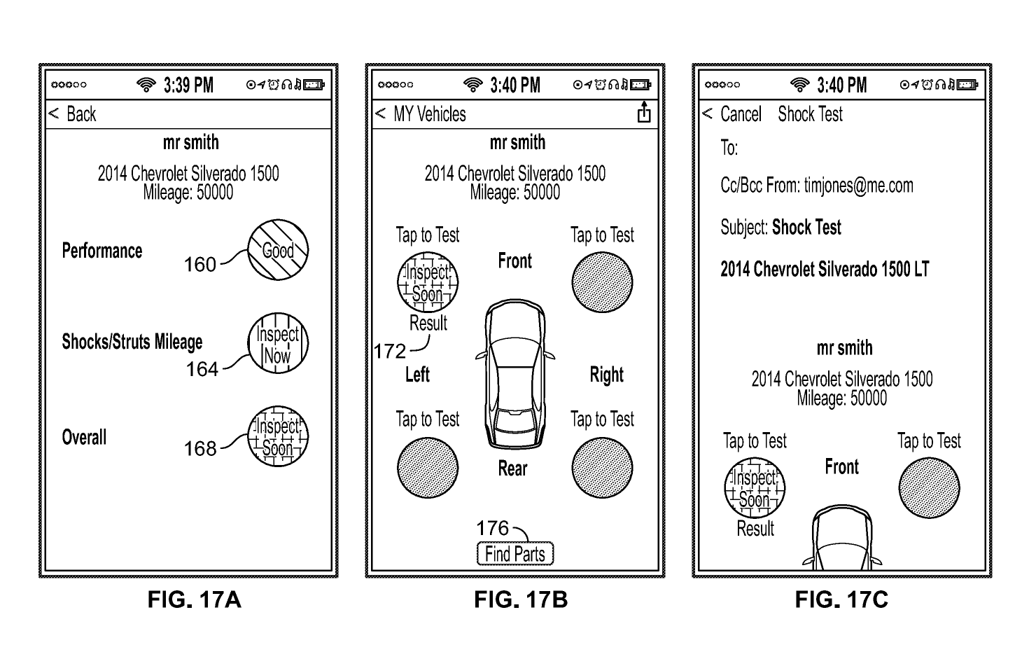

Further, the results display module 59 can cause the mobile communication device 20 to display icons 160, 164, 168 illustrating the predictions determined from the overall predictive value, damping performance, and/or shock mileage scores. In the example screen of FIG. 17A, a green “Pass” or “Good” icon 160 is displayed for the damping performance based on the damping performance score, a red “Inspect now” icon 164 is displayed for the shock mileage based on the shock mileage score, and a yellow “Inspect Soon” icon 168 is displayed for the overall prediction based on the predictive value. Alternatively, only one or two of the above icons may be shown.

The results display module 59 may also display recommendations based on the damping performance score individually, the shock mileage/life score individually, and/or the overall shock performance prediction score as compared to the respective grading matrices for each score. The recommendations can be text-based and/or icon-based (icons 160, 166, 168), both of which are illustrated in FIG. 17A. This provides appropriate suggestions and recommendations to the user for servicing the shock directly on the display 26 of the mobile communication device 20.

FIG. 17B shows a summary of the shock performance test results for the selected vehicle, which can be provided by the results display module 59 in combination with the display 26. The summary results in FIG. 17B includes the display shown in FIG. 6C, now updated to include an icon and text information for the overall recommendation for the tested corner of the selected vehicle. A link 172 to the complete results, e.g., as shown in FIG. 17A, can also be provided. In addition to being displayed on the display 26 of the mobile communication device 20, the results may also be stored (e.g., in the memory or storage of the mobile communication device or an external device), printed, communicated to an external device, e.g., via email (as shown in FIG. 17C), text, etc., or uploaded to a network (e.g., the Internet, WAN, LAN, etc.).

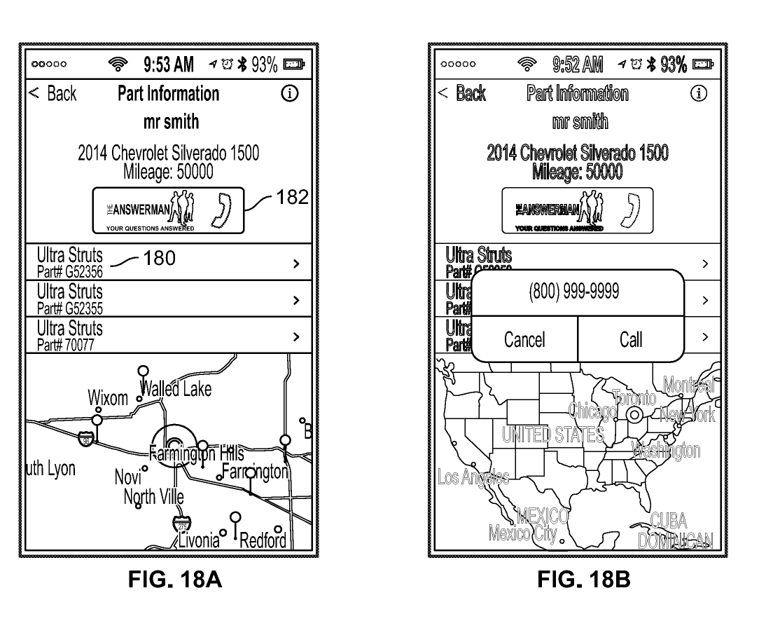

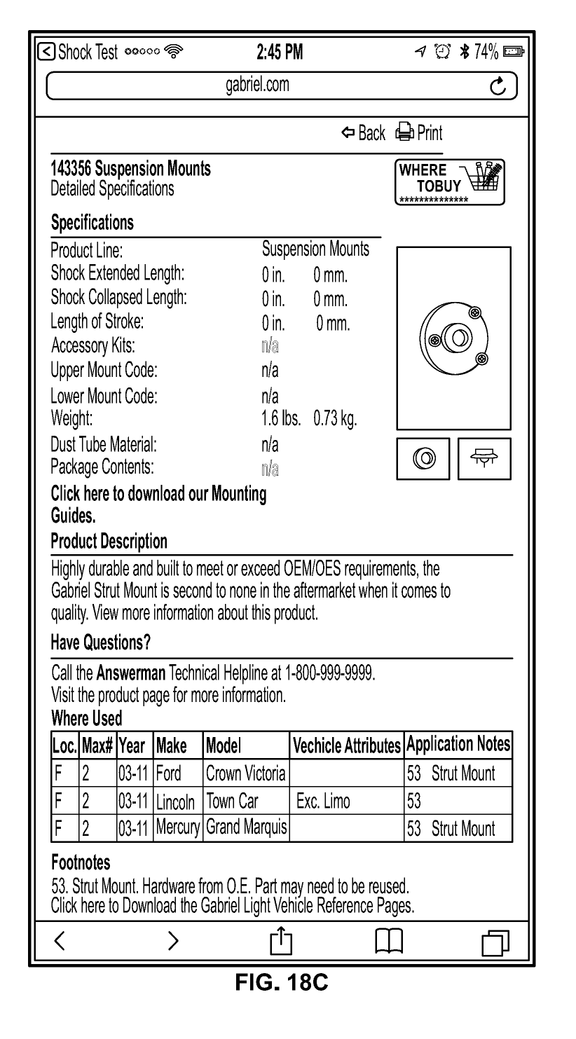

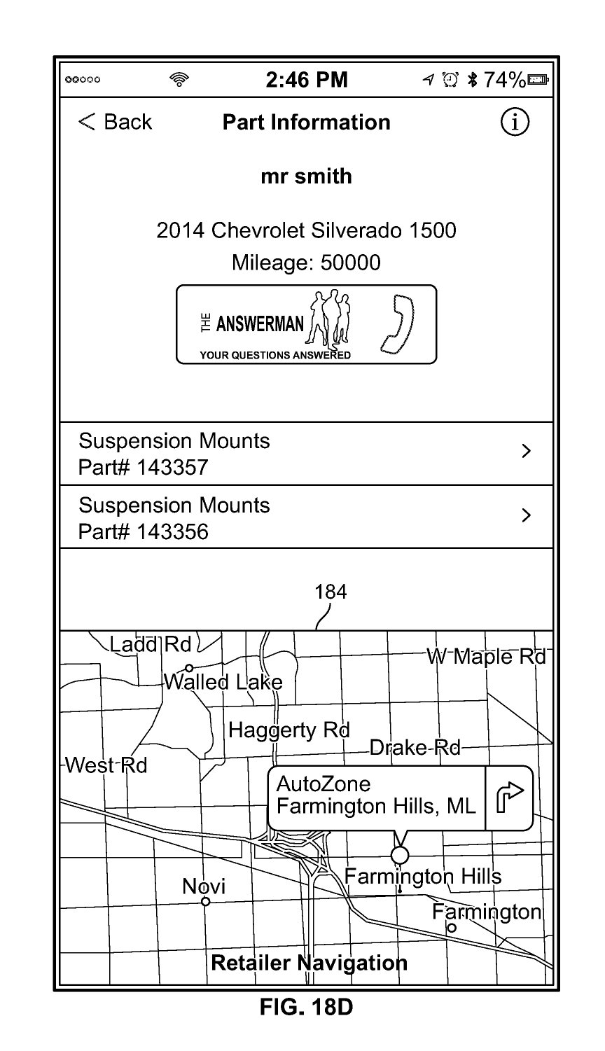

As also shown for example in FIG. 17B, the display may include a link 176 for allowing a user to find replacement parts, e.g., shocks or struts, for a vehicle. FIGS. 18A-18D show example screenshots that may be provided by the mobile app. FIG. 18A shows a selectable parts list 180 for replacement shocks or struts for the selected vehicle. A phone icon 182 is provided for allowing a user to initiate a phone call to a parts retailer directly from the mobile app via the mobile communication device 20, as shown in FIG. 18B. The parts list 180 may also link to external webpages, for instance as shown in FIG. 18C, providing part information. Further, the mobile app may include or provide an embedded map 184, for instance as shown in FIG. 18D, for navigating to the parts retailer.

Thus, example mobile apps, mobile communication devices running the mobile apps, and systems including the mobile communication devices allow a user to easily and reliably estimate shock performance. User prompts, data collection, data processing, user feedback, and (preferably) replacement parts ordering can all be performed using a single mobile communication device running an example mobile app. Results can be provided along with recommendations for the user, preferably in a clear, visible manner. Links and icons may be provided for further assistance, retrieving results, performing new tests, ordering parts, or locating a parts dealer or service.

A person of ordinary skill in the art would understand that the example mobile app may be implemented in the mobile communication device 20 by one or more modules described herein as well any other additional modules such that a person of ordinary skill in the art may refer to such embodiments as an application platform. Further, the modules and functions thereof may be combined or separated. In addition, such modules can be separated and portions thereof may be implemented across many devices or combined into one device.

Each of the communication interfaces may be software or hardware associated in communicating to other devices. The communication interfaces may be of different types that include a user interface, USB, Ethernet, Wi-Fi, wireless, optical, cellular, or any other communication interface coupled to a communication network.

Persons of ordinary skill in the art will understand that embodiments of example methods may include a subset of the steps shown and described in the figures as well as the order of the steps may be rearranged. Further, additional steps may be implemented by the method before, after, and in between the steps shown and described in the figures. In addition, the steps of example methods may be implemented by one or more modules executed by one or more computing devices as described herein.

In addition, the mobile communication device(s) 20 preferably also has/have one or more communication interfaces. The mobile communication device(s) 20 may include one or more processors 22 that may be co-located with each other or may be located in one module or in different parts of a computing device, or among a plurality of computing devices. The memory 23 may include one or more storage devices that may be co-located with each other or may be located in one module, in different parts of a computing device or among a plurality of computing devices. Types of memory may include, but are not limited to, electronic memory, optical memory, and removable storage media. An intra-device communication link between processor(s), memory device(s), modules, antennas, and communication interfaces may be one of several types that include a bus 34 or other communication mechanism.

The modules disclosed herein may be implemented by the one or more processors. Further, the modules and functions thereof may be combined or separated. In addition, such modules can be separated and portions thereof may be implemented across many devices or combined into one device.

Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. Also, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as a processor, or processors, with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as modules. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

While particular embodiments of the present method for estimating shock performance of a vehicle using a mobile communication device have been shown and described, it will be appreciated by those skilled in the art that changes and modifications may be made thereto without departing from the invention in its broader aspects and as set forth in the following claims.

1. A method for estimating shock performance of a vehicle using a mobile communication device, the method comprising:
receiving acceleration data from one or more motion sensors of the mobile communication device over a period of time while the mobile communication device is placed on a portion of the vehicle and forced vibration is given to a suspension of the vehicle;
processing the received acceleration data to estimate a performance of the shock; and
displaying the estimated performance of the shock on a display of the mobile communication device.

2. The method of claim 1, wherein estimating performance of the shock comprises estimating a damping performance of the shock;
wherein said processing the received acceleration data comprises:
calculating a damping coefficient using the received acceleration data; and
estimating the damping performance based on the calculated damping coefficient.

3. The method of claim 2, wherein said estimating the damping performance comprises:
comparing the calculated damping coefficient to a table relating damping coefficients to estimated damping performance.

4. The method of claim 2, wherein said calculating the damping coefficient comprises:
recording acceleration changes using the received acceleration data;
filtering the recorded acceleration changes;
converting the filtered acceleration changes to displacement data; and
calculating the damping coefficient using the displacement data.

5. The method of claim 4, wherein said calculating the damping coefficient using the displacement data comprises:
calculating a logarithmic decrement using peaks in the displacement data; and
calculating the damping coefficient using the calculated logarithmic decrement.

6. The method of claim 4, wherein said converting the filtered acceleration changes to displacement data comprises:
integrating the filtered acceleration changes to provide velocity data;
additional filtering the velocity data; and
integrating the additionally filtered velocity data to provide the displacement data.

7. The method of claim 4, further comprising:
further filtering the displacement data before said calculating the damping coefficient using the displacement data.

8. The method of claim 1, further comprising:
displaying a prompt of the display of the mobile communication device for prompting a user to begin vibrating the vehicle suspension.

9. The method of claim 8, wherein the prompt comprises:
a picture of a vehicle;
an indicator indicating the portion of the vehicle; and
an icon that is selectable by the user to begin vibrating the vehicle suspension.

10. The method of claim 9, wherein the prompt further comprises a sequence of displayed messages in response to selection of the icon.

11. The method of claim 1, wherein estimating performance of the shock comprises:
estimating a damping performance of the shock; and
estimating a shock mileage performance based on an estimated shock mileage.

12. The method of claim 11, wherein said estimated shock mileage is received from an input.

13. The method of claim 11, wherein said estimating a shock mileage performance comprises:
comparing the estimated shock mileage to a table relating estimated shock mileage to estimated shock mileage performance.

14. The method of claim 11, further comprising:
combining the estimated damping performance and the estimated shock mileage performance to determine an overall shock performance prediction.

15. The method of claim 14, further comprising;
displaying at least one of the estimated damping performance, the estimated shock mileage performance, or the overall shock performance prediction on the display of the mobile communication device.

16. The method of claim 15, further comprising:
determining at least one recommendation based on the estimated damping performance, the estimated shock mileage performance, or the overall shock performance prediction on the display of the mobile communication device; and
further displaying said determined at least one recommendation.

17. The method of claim 1, wherein the one or more motion sensors comprise one or more accelerometers.

18. An apparatus for estimating shock performance of a vehicle using a mobile communication device, the apparatus comprising:
a processor; and
executed instructions stored on a non-transitory medium that when executed by the processor cause the processor to:
receive acceleration data from one or more motion sensors of the mobile communication device over a period of time while the mobile communication device is placed on a portion of the vehicle and forced vibration is given to a suspension of the vehicle;
process the received acceleration data to estimate a performance of the shock; and
display the estimated performance of the shock on a display of the mobile communication device.

19. The apparatus of claim 18, wherein estimating performance of the shock comprises:
estimating a damping performance of the shock; and
estimating a shock mileage performance based on an estimated shock mileage.

20. A mobile communication device comprising the apparatus of claim 18;
wherein the mobile communication device further comprises:
the one or more motion sensors; and
the display.

21. An apparatus for estimating shock performance of a vehicle using a mobile communication device, the apparatus comprising:
a processor;
a damping performance determination module configured for causing the processor to receive acceleration data from one or more motion sensors of the mobile communication device over a period of time while the mobile communication device is placed on a portion of the vehicle and forced vibration is given to a suspension of the vehicle;
a shock mileage determination module configured for causing the processor to estimate a shock mileage performance based on an estimated shock mileage;
a prediction determination module configured for causing the processor to combine the estimated damping performance and the estimated shock mileage performance to determine an overall shock performance prediction;
a user prompt module configured for causing the processor to prompt a user to begin oscillating the vehicle; and
a results display module configured for causing the processor to display one or more of the estimated damping performance, the estimated shock mileage performance, or the overall shock performance prediction on the display of the mobile communication device.

22. The apparatus of claim 21, wherein the one or more motion sensors comprises one or more accelerometers.
